(19) United States
(12) Patent Application Publication
(10) Pub. No.: US 2021/0126538 A1
(43) Pub. Date: Apr. 29, 2021

(54) BOOTSTRAP CAPACITOR REFRESHING FOR INVERTING BUCK-BOOST DC-DC CONVERTERS

(71) Applicant: TEXAS INSTRUMENTS INCORPORATED, Dallas, TX (US)

(72) Inventors: Emiliano Alejandro Puia, Giggenhausen (DE); Gaetano Maria Walter Petrina, Mauern (DE); Puneet Sareen, Freising (DE)

(21) Appl. No.: 17/038,410

(22) Filed: Sep. 30, 2020

Related U.S. Application Data
(60) Provisional application No. 62/926,247, filed on Oct. 25, 2019.

(51) Int. Cl. H02M 3/158; H02M 1/08

(52) U.S. Cl. CPC H02M 3/1582; H02M 1/08

(57) ABSTRACT

A converter having an input adapted to be connected to an input voltage and an output adapted to supply an output voltage, the converter comprising: a high-side switch having a first current terminal, a second current terminal and a first control terminal, the first current terminal is coupled to the input voltage and the second current terminal is coupled to a switching node; a high-side driver circuit having an input, a first supply input, a second supply input and an output coupled to the first control terminal, the second supply input is coupled to the switching node; a bootstrap capacitor having a first terminal and a second terminal, the first terminal coupled to the first supply input and the second terminal coupled to the second supply input; a switch having a first terminal and a second terminal, the first terminal of the switch is coupled to the first terminal of the bootstrap capacitor and the second terminal of the switch is connected to a supply voltage (V_{DD} volts above ground).

### CROSS-REFERENCE TO RELATED APPLICATIONS

The application claims priority to US Provisional Application No. 62/926,247, filed Oct. 25, 2019 entitled “Bootstrap Capacitor Refreshing for Inverting Buck-Boost DC-DC Converters”, which is hereby incorporated herein by reference in its entirety.

### BACKGROUND

Battery operated devices, such as personal electronic devices, robots, electric cars, industrial equipment, medical equipment and wearable devices, require a stable and consistent power source. In addition, longer battery life is desirable so high efficiency (especially during light loads) is important. Highly efficient voltage regulators may be used in these applications to provide a regulated voltage from the battery to the device while requiring less battery power to operate. In addition, display devices (such as organic light-emitting diode displays and LCD displays) also incorporate voltage regulators. A stable output voltage with minimal ripple is important for the proper operation of these display devices.

Switching regulators, also referred to as DC-DC converters, are used to convert or regulate an input voltage to an output voltage. The input voltage can be greater than, less than or equal to the output voltage. If the input voltage is greater than the output voltage, the converter/regulator may be referred to as a “step-down” converter/regulator or a “buck converter”. FIG. 1A illustrates a basic buck converter. If the input voltage is less than the output voltage, the converter/regulator may be referred to as a “step-up” converter/regulator or a “boost converter”. FIG. 1B illustrates a basic boost converter. If the converter/regulator can perform both step-up and step-down functions, then it may be referred to as a “buck-boost converter”. FIG. 1C illustrates an inverting buck-boost converter. While the circuits of FIGS. 1A, 1B and 1C show a two-pole switch, any type of switch or a transistor (such as a bipolar junction transistor, an n-type metal-oxide-silicon transistor (nMOSFET), a p-type MOSFET (pMOSFET) or a lateral diffusion MOSFET (LDMOSFET)) can be used.

Generally, switching regulators include at least one power switch and one or more energy storage devices, such as an inductor and a capacitor. The power switch can be implemented using a metal-oxide-silicon field-effect transistor (MOSFET), bipolar junction transistor (BJT) or other type of power transistor. The switching regulator may include a high-side switch and a low-side switch or a single power switch and a diode. FIG. 1a, 1b and 1c illustrate converters using a single power switch and a diode. To implement the high-side/low-side configuration, the diode can be replaced with a transistor, where, in the case of a MOSFET, one source/drain region is connected where the anode of the diode was and the other source/drain region is connected where the cathode of the diode was. Operation of the switching regulator basically includes turning on the power switch to supply energy to the inductor followed by turning off the power switch resulting in the transfer of the stored energy in the inductor to a load (and an output capacitor). The switching on and off of the power switch is controlled based on the load characteristics and the energy required by the load.

As discussed above, each of the converters illustrated in FIG. 1A, 1B and 1C may be implemented with an active switch (shown by the two-pole switch labeled as “switch” in each of FIG. 1a, 1b and 1c) and a diode or a rectifying switch (not shown). FIG. 1D illustrates an inverting buck-boost converter using a high-side switch (labeled as “HS”) and a low-side switch (labeled as “LS”). Both switches are implemented using n-type MOSFETs (nMOSFETs), but other types of transistors may be used instead. FIG. 1D also illustrates an optional connection to ground and an input bypass capacitor, C₁, for stabilization of the bus voltage during transient events. As the name might suggest, the output voltage of the inverting buck-boost converter is inverted in comparison to the output voltage for the buck converter (FIG. 1A) and the boost converter (FIG. 1B). In FIG. 1A and 1B, the positive side of V_{IN} and V_{OUT} are on the top rail. However, for the inverting buck-boost converters depicted in FIG. 1C and 1D, the positive side of V_{IN} is on the top rail while the positive side of V_{OUT} is on the bottom rail.

### SUMMARY

A converter having an input adapted to be connected to an input voltage and an output adapted to supply an output voltage, the converter comprising: a high-side switch having a first current terminal, a second current terminal and a first control terminal, the first current terminal is coupled to the input voltage and the second current terminal is coupled to a switching node; a high-side driver circuit having an input, a first supply input, a second supply input and an output coupled to the first control terminal, the second supply input is coupled to the switching node; a bootstrap capacitor having a first terminal and a second terminal, the first terminal coupled to the first supply input and the second terminal coupled to the second supply input; a switch having a first terminal and a second terminal, the first terminal of the switch is coupled to the first terminal of the bootstrap capacitor and the second terminal of the switch is connected to a supply voltage (V_{DD} volts above ground). In an embodiment, the converter further includes: a low-side switch having a third current terminal, a fourth current terminal and a second control terminal, the third current terminal is coupled to the switching node and the fourth current terminal is coupled to the output voltage; and/or an inductor having a first terminal coupled to the switching node and a second terminal coupled to ground. In an embodiment, the switch is operable to connect the first terminal of the bootstrap capacitor to the supply voltage during a time period while the high-side switch and the low-side switch are turned off (for an off-time duration). In an embodiment, the time period is shorter than the off-time duration, but is long enough to recharge the bootstrap capacitor by the supply voltage during the time period. In an embodiment, the bootstrap capacitor is recharged by the supply voltage when the switch is closed, and the switch closed for a recharge period: at start-up of the converter; and/or if the high-side switch and the low-side switch are turned off.

Another embodiment is an inverting buck-boost converter adapted to be coupled to a first supply terminal of a voltage source having a second supply terminal connected to ground, the inverting buck-boost converter comprising: a high-side switch having a first current terminal, a second current terminal and a first control terminal, the first current terminal is adapted to be coupled to an input voltage and the second current terminal is coupled to a switching node; a low-side switch having a third current terminal, a fourth current terminal and a second control terminal, the third current terminal is coupled to the switching node and the fourth current terminal is coupled to an output of the inverting buck-boost converter; a high-side driver having a first input, a first supply input, a second supply input and an output coupled to the first control terminal; a bootstrap capacitor having a first terminal coupled to the first supply input and a second terminal coupled to the second supply input and the switching node; and wherein the first terminal of the bootstrap capacitor is adapted to be coupled to the first supply terminal of the voltage source for a first time period. In an embodiment, the first time period occurs: at start-up of the inverting buck-boost converter; or for a portion of time that the high-side switch and the low-side switch are turned off. In an embodiment, the bootstrap capacitor is recharged by the voltage source during the first time period. The first supply terminal has a voltage potential (V_{DD}) with reference to ground.

Another embodiment is an inverting buck-boost comparator adapted to be coupled to a voltage supply having a first voltage supply terminal and a ground terminal connected to ground, the inverting buck-boost converter comprising: a high-side transistor having a gate, a drain coupled to an input voltage and a drain coupled to a switching node; a high-side gate driver having a first supply input, a second supply input coupled to the switching node and an output coupled to the gate of the high-side transistor; a bootstrap capacitor having a first end coupled to the first supply input of the high-side gate driver and a second end coupled to the second supply input of the high-side gate driver; and a switch having a first end connected to the first voltage supply terminal and a second end coupled to the first end of the bootstrap capacitor. The first voltage supply terminal supplies a first voltage value with respect to ground. In an embodiment, the switch is operable to connect the first voltage supply terminal to the bootstrap capacitor to recharge the bootstrap capacitor when the switch is closed.

### BRIEF DESCRIPTION OF THE DRAWINGS

For a detailed description of various examples, reference will now be made to the accompanying drawings in which:

FIG. 1A is a schematic diagram of a traditional buck converter;

FIG. 1B is a schematic diagram of a traditional boost converter;

FIG. 1C is a schematic diagram of a traditional inverting buck-boost converter;

FIG. 1D is a schematic diagram of a traditional inverting buck-boost converter that utilizes high-side and low-side transistors;

FIGS. 2A and 2B are schematic diagrams of inverting buck-boost converters of an example embodiments.

FIG. 3A is a timing diagram illustrating an example embodiment for a converter at start-up.

FIG. 3B is a timing diagram illustrating an example embodiment for an open-loop controller.

FIG. 3C is a timing diagram illustrating an example embodiment for a closed-loop controller.

FIG. 4A is a block diagram illustrating an example embodiment for an open-loop analog timer.

FIG. 4B is a block diagram illustrating an example embodiment for an open-loop digital timer.

FIG. 4C is a block diagram illustrating an example embodiment for a closed-loop analog timer.

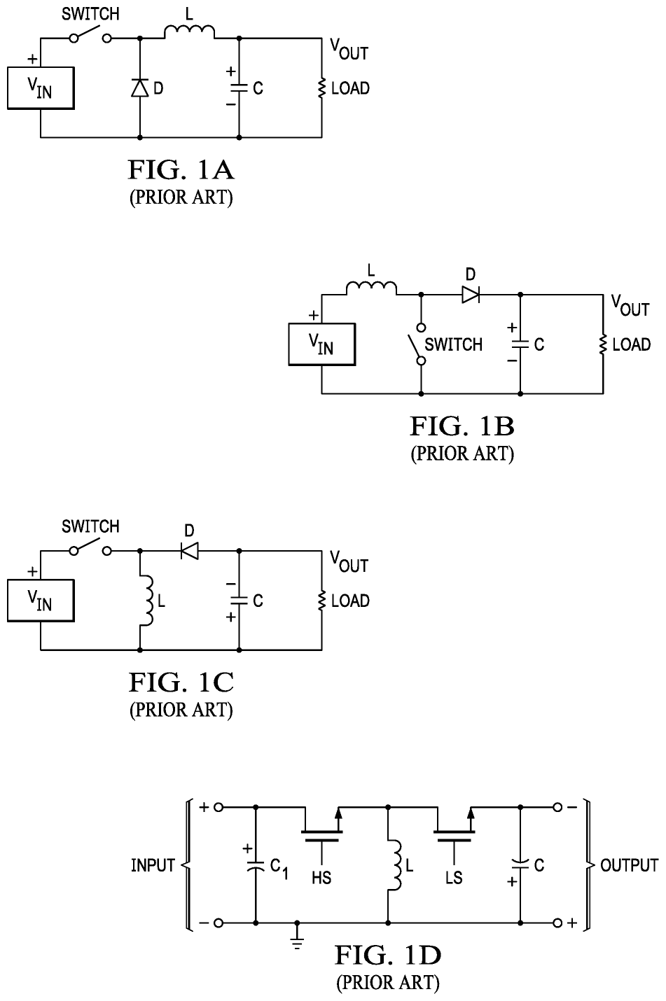

### DETAILED DESCRIPTION

Whenever an n-type transistor is used as the high-side (HS) switch in the power stage of an inverting buck-boost converter, a potential above the input voltage (V_{IN}) should be generated in order to turn this transistor on. One approach for producing this potential (V_{BST}) is to employ a bootstrap capacitor (C_{BST}) which acts as a floating supply for the high-side switch driver and which is connected between the switching node (LX) and the V_{BST} voltage.

In some example embodiments, the charge replenishment of C_{BST} is achieved by means of a voltage supply V_{NDRV_HS}, which is V_{DD} volts above V_{OUT}, and a diode connected between the V_{NDRV_HS} supply and V_{BST}. Specifically, when the low-side (LS) switch is turned on, the LX node is pulled to V_{OUT} and this causes the bootstrap diode to be forward biased and C_{BST} to be recharged through V_{NDRV_HS} up to V_{DD} volts (with respect to V_{OUT}).

The bootstrap capacitor will be properly refreshed when the LX node is at V_{OUT}. In many applications, however, a “high impedance” state may occur after the period when the low-side switch is on and the high-side switch is off. The “high impedance” state may occur at other times, too. During the “high impedance” state, the low-side switch and the high-side switch are off and the inductor is discharged. This causes the LX node to be at (or near) a ground potential. During the high impedance state, the normal refresh mechanism through V_{NDRV_HS} and the bootstrap diode will not occur.

If the converter remains in the “high impedance” state for an extended duration, the bootstrap capacitor might discharge (either by bias or by leakage currents) to a voltage level that does not ensure the correct operation of the high-side driver. If this occurs, the high-side driver may not able to turn on the high-side switch.

In an example embodiment, the low-side switch can be turned on for a short duration after the high impedance state. The short duration should be long enough to “recharge” the bootstrap capacitor. While this approach may be effective for recharging the bootstrap capacitor, it can cause excessive output ripple. In addition, converter efficiency may decrease during light loads (especially if the duration of the on-time for the low-side switch is too long).

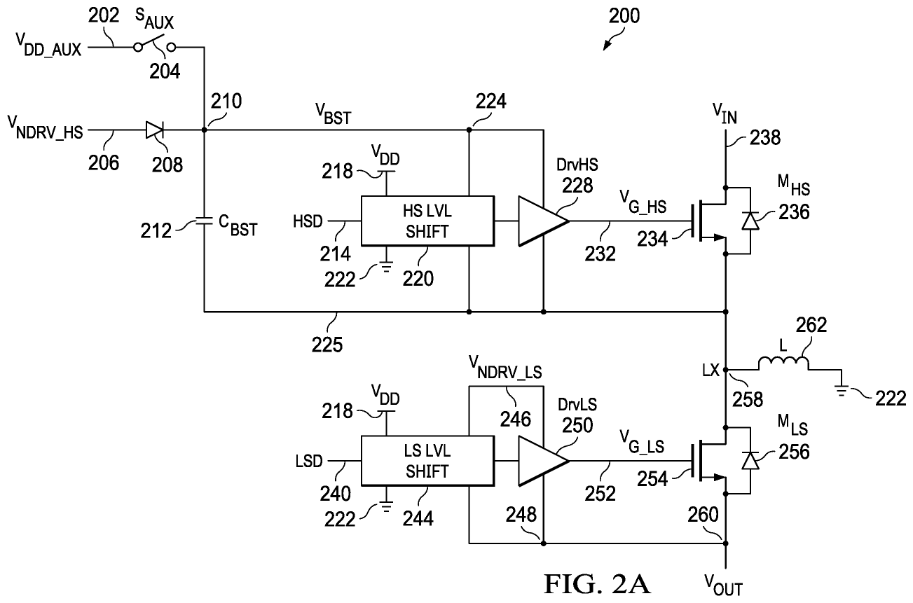

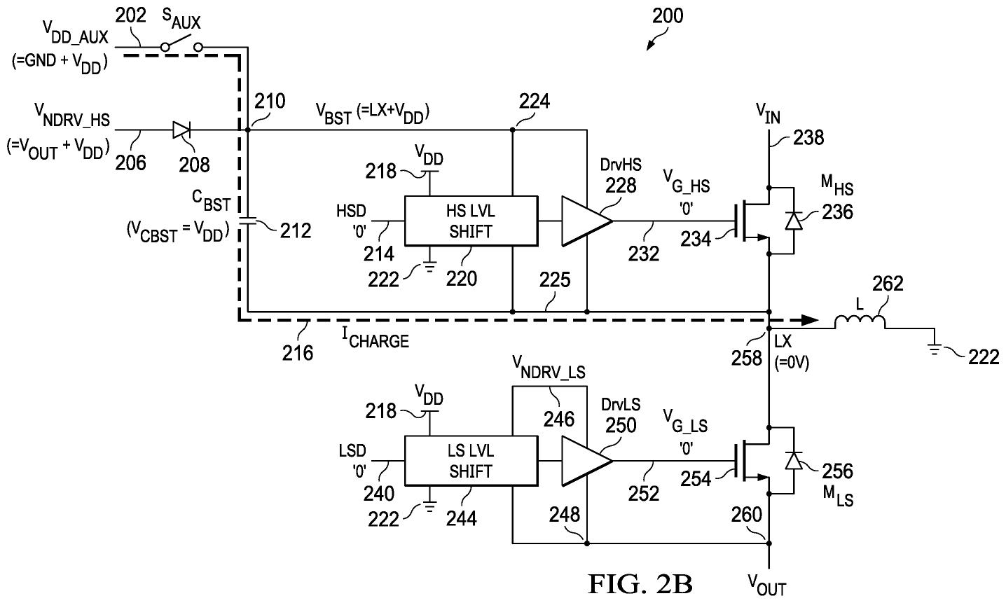

Referring to FIG. 2A, inverting buck-boost converter 200 of an example embodiment includes high-side (HS) switch 234 and low-side (LS) switch 254. HS switch 234 and LS switch 254 can be metal-oxide-silicon field effect transistors (MOSFET), a laterally-diffused MOSFETs (LDMOS), a bipolar transistors (BJT) or other type of transistors. In FIG. 2 HS switch 234 is depicted as an n-type MOSFET (nMOSFET) and LS switch 254 is also depicted as an nMOSFET. Both HS switch 234 and LS switch 254 are depicted with body diodes 236 and 256, respectively. The source of HS switch 234 and the drain of LS switch 254 are connected to switching node (LX) 258. The drain of HS switch 234 is connected to the input supply (V_{IN}) 238 and the source of LS switch 254 is connected to the output (V_{OUT}) 260. Energy storage device 262 is depicted as an inductor in FIG. 2A (it may include an inductor, a capacitor or both devices) and is connected between LX node 258 and ground 222.

HS switch 234 is “driven” (meaning to turn on or off) by drive signal V_{G_HS}, which is the output of HS gate driver 228. The output of HS gate driver 228 is based on the output of HS level shifter 220, which is based on a control signal HSD 214 received by HS level shifter 230. Control signal 214 defines which mode of operation (such as continuous conduction mode (CCM), discontinuous conduction mode (DCM), pulse frequency modulation mode (PFM), pulse width modulation mode (PWM) or modes of operation used by conventional converters) the HS switch 234 is operating in and controls whether the HS switch is conducting (on) or non-conducting (off). Similarly, LS switch 254 is driven (turned on, conducting, or off, non-conducting) by drive signal V_{G_LS}, which is the output of LS gate driver 250. LS level shifter 244 receives a low-side control signal (LSD) 240 and outputs a level-shifted signal to LS gate driver 250. LSD control signal 240 controls the state of operation (such as CCM, DCM, PFM, PWM or modes of operation used by conventional converters) for LS switch 250. In most modes of operation, either HS switch 234 is on (with LS switch 254 turned off) or LS switch 254 is on (with HS switch 234 turned off). However, as discussed above, an issue can arise if both HS switch 234 and LS switch 254 are off (also referred to as being in a “tri-state mode” or a “high impedance mode”). This can occur during a PWM mode of operation where the switching frequency is low (such as during light load conditions) or during startup of the converter and can cause insufficient charging of the bootstrap capacitor.

HS level shifter 220 and LS level shifter 244 are connected to first supply 218, V_{DD}, and second supply 222, ground. In addition, HS level shifter 220 and HS gate driver are connected to V_{BST} 224 and rail 225 (which is equivalent to the potential at switch node 258). Bootstrap capacitor, C_{BST}, causes V_{BST} to remain at a potential that is around the potential of the switching node, V_{LX}, plus V_{DD}. V_{BST} and V_{LX} are voltage supplies for HS gate driver 228. LS level shifter 244 and LS gate driver 250 are connected to V_{NDRV_LS} supply 246 and V_{OUT} 260. V_{NDRV_LS} supply 246 and VOUT are voltage supplies for LS gate driver 250.

V_{NDRV_HS} supply 206 is supplied to the anode of diode 208. V_{NDRV_HS} supply 206 is set to a value around V_{OUT} plus V_{DD}. Since converter 200 is an inverting buck-boost converter, the value of V_{OUT} will have the opposite polarity as V_{IN}. Hence, the value at the cathode of diode 208 may be less than V_{DD}. However, the potential at node 210 may be increased (to, for example, refresh the charge on the bootstrap capacitor 212) if S_{AUX} switch 204 is closed, thereby connecting node 210 (which is connected on one plate of the bootstrap capacitor 212) to V_{DD_AUX} supply 202. The value of V_{DD_AUX} supply 202 is around V_{DD} plus ground (roughly V_{DD}). Diode 208 may be replaced with a switch (not shown) to eliminate the forward voltage drop of the diode.

Referring to 2B, as discussed above, inverting buck-boost converters (such as inverting buck-boost converter 200) may have an issue if the charge stored in bootstrap capacitor 212 is insufficient to turn on HS switch 234. Insufficient charge in bootstrap capacitor 212 may occur at start-up of converter 200, during PFM mode of operation for light loads (causing the switching frequency to be low) or following a period when both HS switch 234 and LS switch 254 are turned off. FIG. 2B illustrates a condition which could result in insufficient charge in bootstrap capacitor 212. As is evidenced by HSD signal 214, VG_HS 232, LSD signal 240 and VG_LS all being at low values (depicted as a logical “0” in FIG. 2B), nMOSFETs 234 and 254 are turned off If switch 204 remains open (or isn't present to connect node 210 to V_{DD_AUX}) and the absolute value of V_{OUT} is sufficiently large, charge replenishment of the bootstrap capacitor 212 by V_{NDRV_HS} and diode 208 may not work. If the bootstrap capacitor has V_{DD} voltage across it, node 210 will be set to a voltage close to V_{DD} since LX node 258 and the lower plate of the bootstrap capacitor 212 will be at a ground potential. Hence, diode 208 is reversed-biased because its anode is at V_{OUT}+V_{DD}, and its cathode is at V_{DD}. As a consequence, the bootstrap capacitor 212 cannot be sufficiently refreshed by means of V_{NDRV_HS}. Under these conditions, leakage or bias currents can discharge this rail to very low voltages that can compromise the operation of the HS level shifter 230 and the HS driver 228.

In some example embodiments switch 204 is included in converter 200. Switch 204 can be implemented by a two-pole switch or a transistor that will provide sufficient isolation between supply V_{DD_AUX} 202 and node 210. If the charge on the bootstrap capacitor 212 is too low, switch 204 may be closed thereby connecting node 210 to V_{DD_AUX} 202 (equal to V_{DD}+ground or V_{DD} with reference to ground). During the period that switch 204 is closed, current I_{CHARGE} 216 flows from V_{DD_AUX} source 202 through bootstrap capacitor 212 and inductor 262 to ground. During this period, the bootstrap capacitor 212 is charged to a potential near V_{DD}. Hence, V_{BST} supply 224 will be around V_{DD}+V_{LX}, and V_{LX} will be around ground potential while HS switch 234 and LS switch 254 are turned off. Once the bootstrap capacitor 212 is sufficiently charged or a predetermined time period (determined to be long enough for bootstrap capacitor 212 to be sufficiently charged) has expired, switch 204 may be opened. Once, HSD signal 214 goes high (logical “1”), bootstrap capacitor 212 will be sufficiently charged to drive HS gate driver 238 to turn on HS switch 234. Charging bootstrap capacitor 212 using switch 204 will cause less V_{OUT} ripple as compared to toggling LS switch 254 to charge bootstrap capacitor 212.

Switch 204 may be switched open (disconnecting V_{DD_AUX} 202 from node 210) or closed (connecting V_{DD_AUX} 202 to node 210) using “closed-loop control” or “open-loop control”. If closed-loop control is used, the voltage across the bootstrap capacitor 212 is monitored (such as by an under voltage lock out circuit, UVLO circuit). If the voltage across bootstrap capacitor goes too low (below V_{BST_MIN}—signifying that the charge is getting too low), a refresh circuit (including switch 202) would be enabled to recharge bootstrap capacitor 212. Closed-loop control is more suitable than open-loop control where the capacitance of bootstrap capacitor 212 is not known (such as when an external capacitor is used instead of capacitor incorporated into the same semiconductor die as the converter) or if the discharge current, I_{DISCH}, through the capacitor is not known.

In instances where the capacitance of bootstrap capacitor 212, C_{BST}, and the value of I_{DISCH} are known, open-loop control may be used. In order to implement open-loop control, a value for the maximum tolerated voltage drop, ΔV_{BST_MAX}, across the bootstrap capacitor 212 should be determined. This value can be the lower supply voltage limit below which the operation of the HS gate driver 228 will no longer reliably turn on HS switch 234. The maximum tolerated discharge time, t_{DISCH_MAX}, can be computed from:

$${t}_{DISCH \_ MAX} = ( Δ {V}_{BST \_ MAX} ) \times \frac{{C}_{BST}}{{I}_{DISCH}} \qquad ( 1 )$$

After the expiration of t_{DISCH_MAX}, switch 202 would be closed for a period of time, t_{PULSE}, calculated to be sufficient to recharge the bootstrap capacitor 212 so that the voltage across the bootstrap capacitor is around V_{DD}.

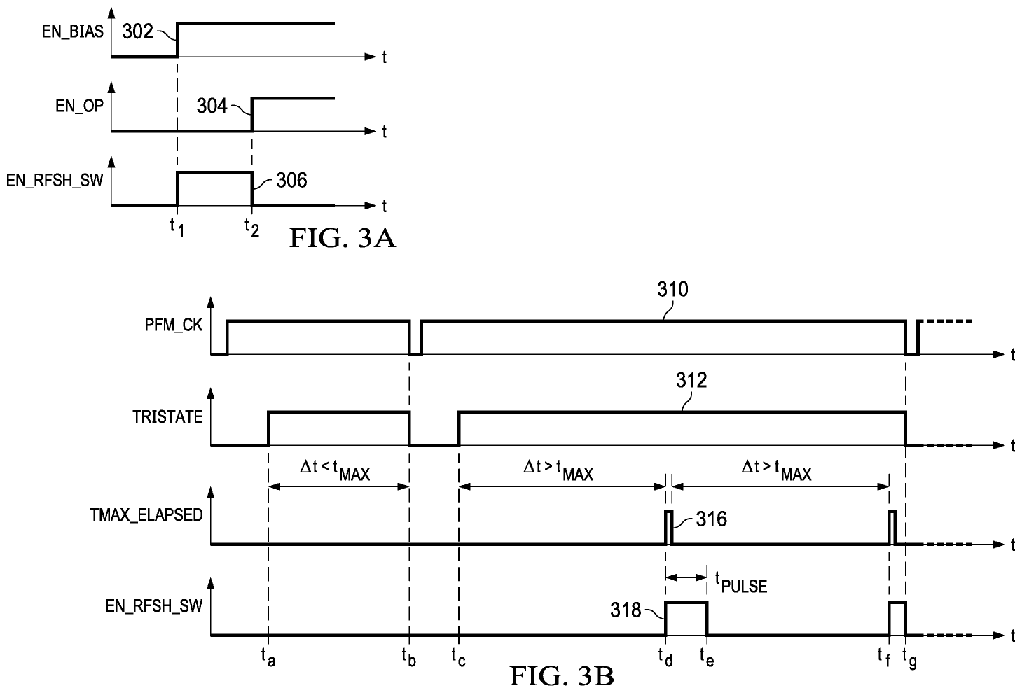

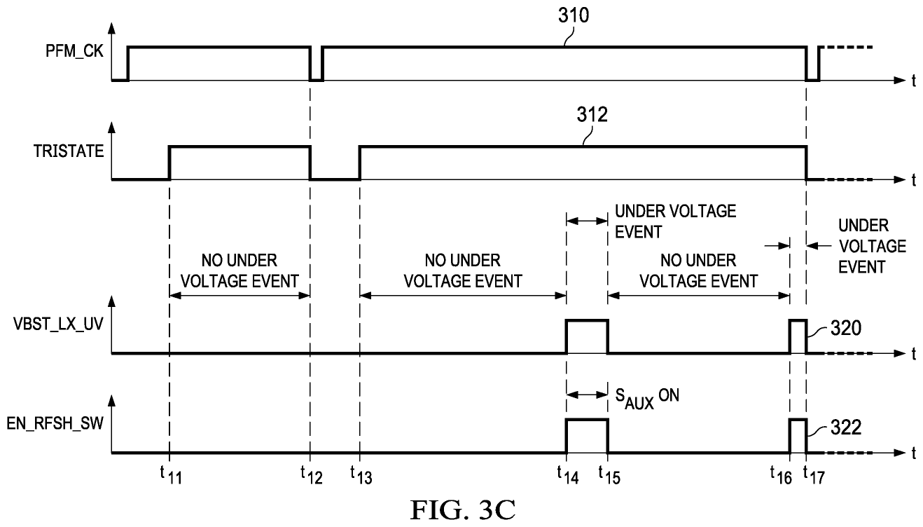

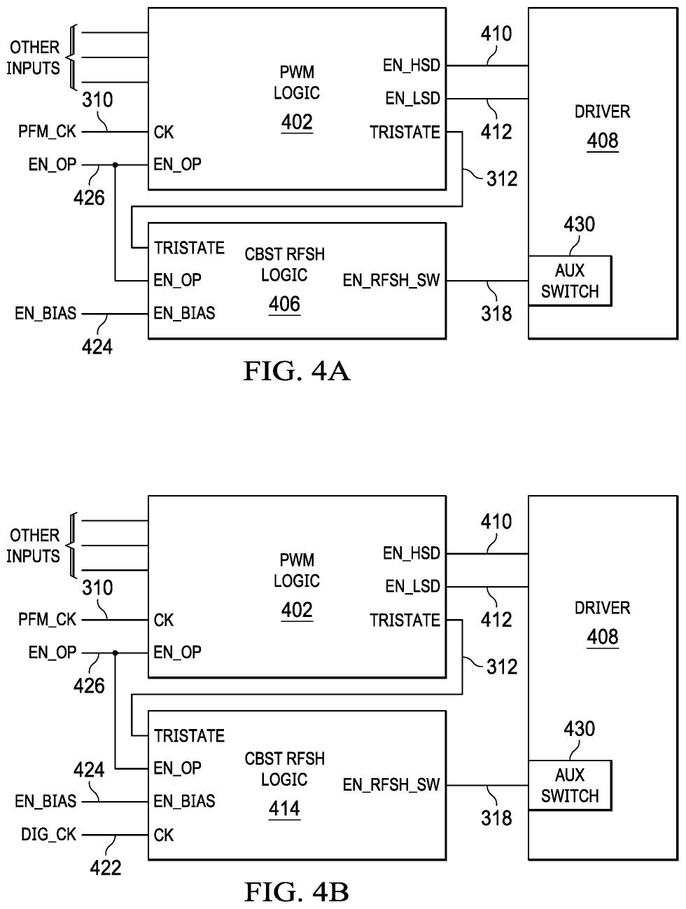

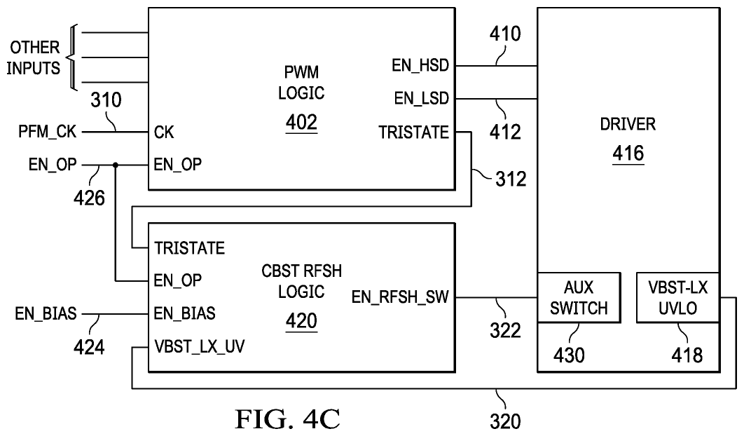

The following description is with reference to the timing diagrams of FIGS. 3A, 3B and 3C and the block diagrams of FIGS. 4A, 4B and 4C. FIGS. 3B and 4A (analog) and 4B (digital) relate to open-loop timers of example embodiments. FIGS. 3C and 4C (analog) relate to closed-loop timers of example embodiments. The example embodiments illustrated these figures can be used to provide timing for an inverting buck-boost converter (such as converter 200). Reference numerals used in the timing diagrams of FIG. 3A, 3B and 3C are also used in FIG. 4A, 4B and 4C for the same signals. Gate drivers 408 and 416 may be implemented as one block of circuitry or it may be implemented as two separate gated drivers (such as high-side gate driver 228 and low-side gate driver 250 of FIGS. 2A and 2B).

FIG. 3A illustrates an example timing sequence for signals utilized in an example embodiment for the start-up of an inverting buck-boost converter (such as converter 200). In particular, EN_BIAS 424 is the signal that enables the bias currents and the internal voltage rails used by the converter. EN_OP 426, instead, is a signal that indicates that the converter can start switching. EN_RFSH_SW 318/322 is the signal that drives the S_{AUX} switch 204, so the S_{AUX} switch 204 is on at start-up as soon as EN_BIAS 424 is high and EN_OP 426 is low. In this way the V_{BST} (the voltage across the bootstrap capacitor) is correctly set (to V_{DD_AUX}), preventing malfunctioning of the HS driver when the converter is started up.

FIG. 3B illustrates an example timing sequence for signals utilized in an example embodiment for an open-loop controller for an inverting buck-boost converter (such as converter 200). Clocking signal 310, PFM_CK, is supplied from a control circuit (not shown) to controller 402 for the clocking of the converter while the converter is operating in the PFM mode. Waveform 312 represents periods when both the high-side switch (such as HS switch 234) and low-side switch (such as LS switch 254) are both off (also referred to as a tri-state mode or high impedance mode). These periods, as provided in this example, are between times tₐ and t_{b} and from t_{c} to t_{g}. Since the time period from tₐ and t_{b}is shorter than t_{DISCH_MAX}, a recharging of the bootstrap capacitor is not necessary (the refresh signal, EN_RFSH_SW 318, does not go “high”) and the T_{MAX_ELAPSED} flag 316 is not set (does not go “high”). However, the time period of t_{c} to t_{g} is twice as long as t_{DISCH_MAX}, so the flag 316 is set twice (at t_{d} and t_{f}) and the recharging of the bootstrap capacitor (by closing switch 202) occurs between t_{d} and tₑ and t_{f} and t_{g}. The duration of each recharging period, t_{PULSE}, is determined based a predetermined timing as discussed above.

FIG. 3C illustrates an example timing sequence for signals utilized in an example embodiment for a closed-loop controller for an inverting buck-boost converter (such as converter 200). Clocking signal 310, PFM_CK, is supplied from a control circuit (not shown) to controller 402 for the clocking of the converter while the converter is operating in the PFM mode. Waveform 312 represents periods when both the high-side switch (such as HS switch 234) and low-side switch (such as LS switch 254) are both off (also referred to as a tri-state mode or high impedance mode). These periods, as provided in this example, are between times t₁₁ and t₁₂ and from t₁₃ to t₁₇. Since the monitored voltage across the bootstrap capacitor (V_{BST}) did not drop below V_{BST_MIN} during the period between t₁₁ and t₁₂, the bootstrap capacitor 212 does not need to be recharged and, therefore, the VBST_LX_UV flag 320 is not set (it does not go “high”). However, during the period between t₁₃ to t₁₇, the voltage (V_{BST}) across the bootstrap capacitor 212 drops below V_{BST_MIN} from t₁₄ to t₁₅ and from t₁₆ to t₁₇. During each of these periods, switch 202 is closed (to recharge the bootstrap capacitor) until the voltage across the bootstrap capacitor increases to around V_{DD_AUX}.

Referring to FIGS. 4A, 4B and 4C, mode controller and logic circuitry 402 is connected to driver 408 (which may include separate drivers for the high-side and low-side switches) by high-side enable signal 410 and low-side enable signal 412. These signals are used to “turn on” the high-side and low-side switches, respectively. Tristate signal 312 is output from circuitry 402 to refresh logic 406 (FIG. 4A), 414 (FIG. 4B) or 420 (FIG. 4C), and this signal represents when controller 200 is in a “tristate” (or high-impedance) mode. EN_OP signal 426 is provided (by a controller) to both circuitry 402 and refresh logic 406/414/420. Since the circuitry of FIG. 4B is implemented by digital logic, digital clock 422 (DIG_CK) is input to refresh logic 414. Refresh signal 318/322 is provided from refresh logic 406/414/420 to the auxiliary switch 430 in driver 408/416. Since the circuitry of FIG. 4C is closed loop, V_{BST_LX_UV} 320 is provided from circuitry 418 in driver 416 to logic 420.

In the foregoing discussion and in the claims, the terms “including” and “comprising” are used in an open-ended fashion, and thus should be interpreted to mean “including, but not limited to . . . .” An element or feature that is “configured to” perform a task or function may be configured (e.g., programmed or structurally designed) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof. Additionally, uses of the phrases “ground” or similar in the foregoing discussion are intended to include a chassis ground, an Earth ground, a floating ground, a virtual ground, a digital ground, a common ground, and/or any other form of ground connection applicable to, or suitable for, the teachings of the present disclosure. Unless otherwise stated, “approximately” preceding a value means +/−10 percent of the stated value. As used herein, the term “modulate” shall also mean “to vary” or “to change.” The terms “node”, “terminal”, “pin” and “interconnection”, for example, are interchangeably used and referred to any connection (or interconnection) between features. These terms are not meant to be limiting with respect to a certain type of physical structure. For example, the “terminals” of a circuit element are meant to be each connection to such circuit element. Hence, an integrated resistor would be referred to have two terminals (ends) even though these “terminals” are just the two connections to the integrated resistor.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

What is claimed is:

1. A converter having an input adapted to be connected to an input voltage and an output adapted to supply an output voltage, the converter comprising:
a high-side switch having a first current terminal, a second current terminal and a first control terminal, the first current terminal is coupled to the input voltage and the second current terminal is coupled to a switching node;
a high-side driver circuit having an input, a first supply input, a second supply input and an output coupled to the first control terminal, the second supply input is coupled to the switching node;
a bootstrap capacitor having a first terminal and a second terminal, the first terminal coupled to the first supply input and the second terminal coupled to the second supply input;
a switch having a first terminal and a second terminal, the first terminal of the switch is coupled to the first terminal of the bootstrap capacitor and the second terminal of the switch is connected to a supply voltage.

2. The converter of claim 1, wherein the supply voltage provides a supply voltage value referenced to ground.

3. The converter of claim 1, further comprising a low-side switch having a third current terminal, a fourth current terminal and a second control terminal, the third current terminal is coupled to the switching node and the fourth current terminal is coupled to the output voltage.

4. The converter of claim 1, further comprising an inductor having a first terminal coupled to the switching node and a second terminal coupled to ground.

5. The converter of claim 3, wherein the switch is operable to connect the first terminal of the bootstrap capacitor to the supply voltage during a time period while the high-side switch and the low-side switch are turned off

6. The converter of claim 5, wherein the high-side switch and the low-side switch are turned off for an off-time duration. The converter of claim 6, wherein the time period is shorter than the off-time duration.

8. The converter of claim 5, wherein the bootstrap capacitor is recharged by the supply voltage during the time period.

9. The converter of claim 1, wherein the bootstrap capacitor is recharged by the supply voltage when the switch is closed.

10. The converter of claim 9, wherein the switch is closed for a recharge period at start-up of the converter.

11. The converter of claim 9, wherein the converter includes a low-side switch coupled between the switching node and the output of the converter and the switch is closed for a recharge period if the high-side switch and the low-side switch are turned off.

12. An inverting buck-boost converter adapted to be coupled to a first supply terminal of a voltage source having a second supply terminal connected to ground, the inverting buck-boost converter comprising:
a high-side switch having a first current terminal, a second current terminal and a first control terminal, the first current terminal is adapted to be coupled to an input voltage and the second current terminal is coupled to a switching node;
a low-side switch having a third current terminal, a fourth current terminal and a second control terminal, the third current terminal is coupled to the switching node and the fourth current terminal is coupled to an output of the inverting buck-boost converter;
a high-side driver having a first input, a first supply input, a second supply input and an output coupled to the first control terminal;
a bootstrap capacitor having a first terminal coupled to the first supply input and a second terminal coupled to the second supply input and the switching node; and
wherein the first terminal of the bootstrap capacitor is adapted to be coupled to the first supply terminal of the voltage source for a first time period.

13. The inverting buck-boost converter of claim 12, wherein the first time period occurs at start-up of the inverting buck-boost converter.

14. The inverting buck-boost converter of claim 12, wherein the first time period occurs for a portion of time that the high-side switch and the low-side switch are turned off.

15. The inverting buck-boost converter of claim 12, wherein the bootstrap capacitor is recharged by the voltage source during the first time period.

16. The inverting buck-boost converter of claim 12, wherein the first supply terminal has a voltage potential with reference to ground.

17. The inverting buck-boost converter of claim 16, wherein the voltage potential is V_{DD}.

18. An inverting buck-boost comparator adapted to be coupled to a voltage supply having a first voltage supply terminal and a ground terminal connected to ground, the inverting buck-boost converter comprising:
a high-side transistor having a gate, a drain coupled to an input voltage and a drain coupled to a switching node;
a high-side gate driver having a first supply input, a second supply input coupled to the switching node and an output coupled to the gate of the high-side transistor;
a bootstrap capacitor having a first end coupled to the first supply input of the high-side gate driver and a second end coupled to the second supply input of the high-side gate driver; and
a switch having a first end connected to the first voltage supply terminal and a second end coupled to the first end of the bootstrap capacitor.

19. The inverting buck-boost comparator of claim 18, wherein the first voltage supply terminal supplies a first voltage value with respect to ground.

20. The inverting buck-boost converter of claim 19, wherein the switch is operable to connect the first voltage supply terminal to the bootstrap capacitor to recharge the bootstrap capacitor when the switch is closed.
